(19) United States
(12) Patent Application Publication
(10) Pub. No.: US 2004/0240388 A1
(43) Pub. Date: Dec. 2, 2004

(54) System and method for dynamic assignment of timers in a network transport engine

(76) Inventors: Lee Albion, Portland, OR (US); Ali S. Oztaskin, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/447,494

(22) Filed: May 28, 2003

(51) Int. Cl. H04L 12/26

(52) U.S. Cl. 370/252

(57) ABSTRACT

A system and method for dynamic assignment of timers in a network transport engine is described. The network transport engine includes a plurality of connections, a plurality of timers, and timer logic to dynamically assign one of the plurality of timers to one of the plurality of connections upon client request.

### BACKGROUND

1. Technical Field Embodiments of the invention relate to the field of network transport engines, and more specifically to dynamic assignment of timers in a network transport engine.

2. Background Information and Description of Related Art On conventional computer systems, the network traffic is handled by the Network Interface Card (NIC). In these systems, the NIC provides the network and the link layer functions, and the transport functions are provided by the Operating System (OS) software. As networking became prevalent and networking speeds improved, the amount of processing power used for the transport functions increased dramatically. Network transport engines reduce the processing overhead by incorporating the transport functions over the conventional NIC functions. TCP/IP Offload Engine (TOE) and InfiniBand Host Channel Adapter (HCA) are examples of Network Transport Engines.

The transport layer provides a reliable communication channel, or connection, between two applications running on different systems that are interconnected via the network fabric. A typical transport layer supports tens of thousands of connections concurrently.

Computer networks may be unreliable. A certain percentage of packets on a network may be expected to be corrupted, or simply lost. On reliable connections, it is the transport layer's responsibility to ensure reliable information exchange between the applications. The transport layers on both ends cooperate to achieve reliable connections. In simple terms, the transport layer on the receiving side checks the packet sequence number to detect dropped packets, sends a positive acknowledgement (ACK) for received packets and/or a negative acknowledgement (NAK) for missing packets. Similarly, the transport layer on the transmitting side expects ACK of the packets within a prescribed time window. If this time window, or timer, expires prior to receipt of ACK, or if it receives a NAK, then it transmits the lost packet(s). This timer is known as a transport timer or ACK timer. On a given networking architecture, there could be need for other timers. InfiniBand Architecture's Resource Not Ready (RNR) timer is an example.

As the number of connections supported by network transport engines increase, the required number of dedicated timers increases proportionally. This makes it increasingly difficult to scale all the resources required to maintain the connections.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a system incorporating the invention.

FIG. 2 is a block diagram illustrating timer logic in greater detail according to an embodiment of the invention.

FIG. 3 is a flow diagram illustrating a method according to an embodiment of the invention.

FIG. 4 is a block diagram illustrating a suitable computing environment in which certain aspects of the illustrated invention may be practiced.

### DETAILED DESCRIPTION

Embodiments of a system and method for dynamic assignment of timers in a network transport engine are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

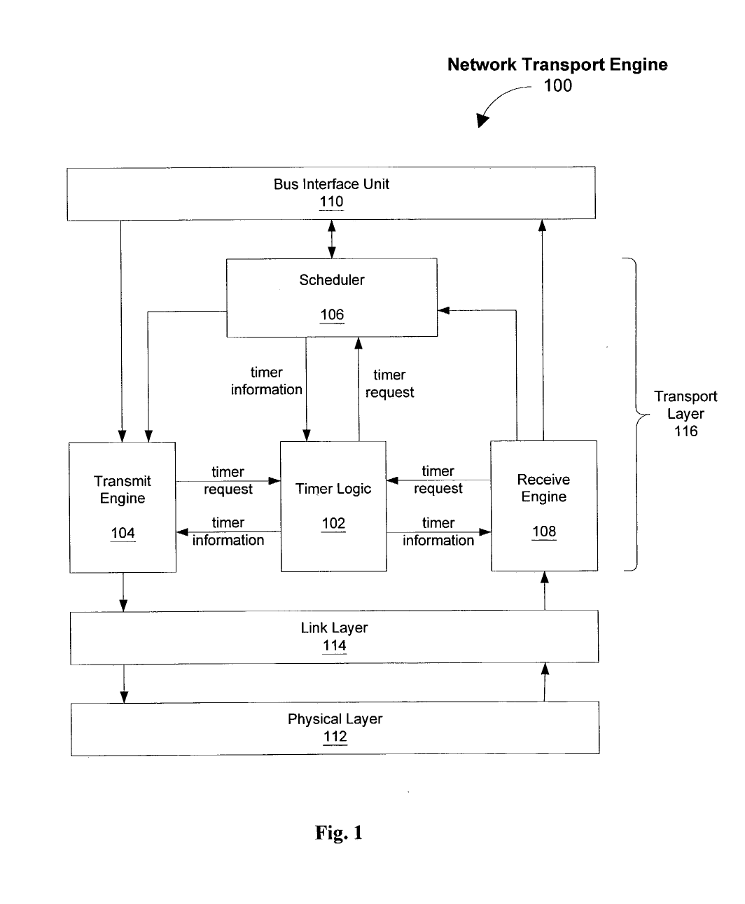

Referring to FIG. 1, a block diagram illustrates a network transport engine 100 according to one embodiment of the invention. Those of ordinary skill in the art will appreciate that the network transport engine 100 may include more components than those shown in FIG. 1. However, it is not necessary that all of these generally conventional components be shown in order to disclose an illustrative embodiment for practicing the invention.

Network transport engine 100 includes a physical layer 112, a link layer 114, and a transport layer 116. The transport engine 100 may also include a bus interface unit 110. Timer logic 102 services other engines, or clients, in the transport layer 116. A client, such as transmit engine 104, scheduler 106, or receive engine 108, sends a request to the timer logic 102 to assign an available timer to a specified connection. The timer logic 102 determines if any of a plurality of timers is available. If there is at least one available timer, the timer logic 102 assigns an available timer to the specified connection. The timer logic 102 then sends information about the assigned timer back to the client. If there are no available timers, the client request is stalled until one of the plurality of timers becomes available. In one embodiment, a client may also make a request to start the assigned timer, to stop the assigned timer, or to de-allocate the assigned timer when the timer is no longer needed.

In one embodiment, the network transport engine 100 may be part of an InfiniBand Host Channel Adapter (HCA), or may be part of an InfiniBand Target Channel Adapter (TCA). The HCA, or TCA, may be connected via an InfiniBand fabric to another HCA or TCA for data transmission.

In one embodiment, the network transport engine 100 may be part of an TCP/IP offload engine (TOE). The TOE may be connected via an IP network fabric to another TOE or NIC for data transmission.

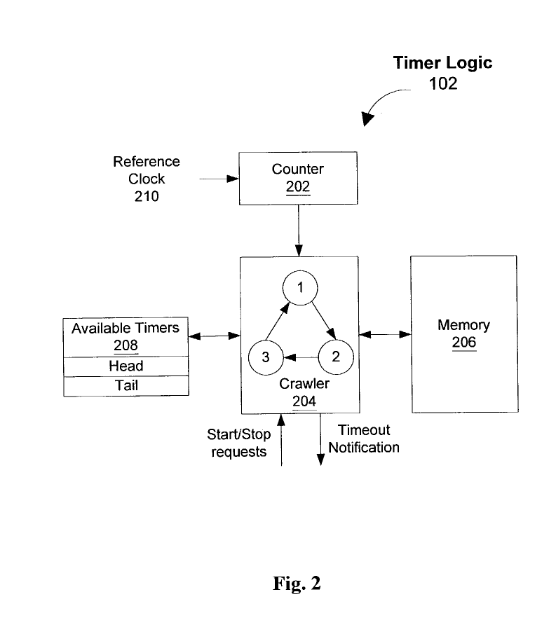

FIG. 2 illustrates the timer logic 102 in greater detail according to one embodiment of the invention. Timer logic 102 includes a counter 202, a crawler 204, a memory 206, and a list of available timers 208. The counter 202 maintains the current time value based on a predetermined time granularity using a reference clock 210. The memory 206 stores the information needed to track the plurality of timers. In one embodiment, each memory location may contain information about a timer. This information may include the connection number that the timer has been assigned to, the timeout value, whether the timer has been allocated, whether the timer has been started or stopped, and the type of timer, such as transport or resource not ready (RNR). Accesses to the memory are controlled by the crawler 204.

The crawler 204 performs various functions including the processing of client requests, detection of timeouts of the timers, notification of timeouts, and management of the list of available timers 208. Client requests may include a request to allocate an available timer to a specified connection, a request to de-allocate a timer, a request to start a timer, or a request to 204 maintains the list of available timers 208, including timers that have not been allocated or timers that have timed out. Available timers list 208 may include head and tail pointers for a linked list of timer locations in memory 206.

The crawler 204 traverses each memory location in memory 206 periodically to check for timed-out timers. At each memory location, crawler 204 checks the state of that timer. If the timer is allocated and started, and the timeout value is equal to the value of counter 202, then the crawler 204 notifies the timer's client that the timer has expired and places that timer into the list of available timers 208. In one embodiment, the memory 206 may be arranged wider to allow access to information of multiple timers in parallel. Timer information may then be fetched on each memory access to check for timed-out timers simultaneously.

Upon a request from a client to allocate a timer, the crawler 204 allocates the timer at the head of the available timers list 208, and updates the head pointer to point to the next timer location in the available timers list 208, which effectively removes the timer from the head of the available timers list 208. The crawler 204 updates the timer's state to allocated, updates the timer's connection to the specified connection number, and returns the timer's identifier to the client. If no timers are available in the available timers 208 list, then the client request is stalled until a timer becomes available.

When a client requests de-allocation of a timer, crawler 204 accesses the memory location of that timer and updates the timer's state to available. Crawler 204 then updates the timer's next pointer to the value of the head pointer in the available timer list 208 and updates the head pointer in the available timer list 208 to the timer's memory location, which effectively returns the timer to the head of the available timers list 208.

When a client requests the starting of a timer, crawler 204 accesses the memory location of that timer, updates the timer's timeout value to the sum of the value of counter 202 and the specified timeout value, and updates the timer's state to started. Similarly, upon receipt of a client's request to stop a timer, the crawler 204 accesses the memory location of that timer and updates the timer's state to allocated.

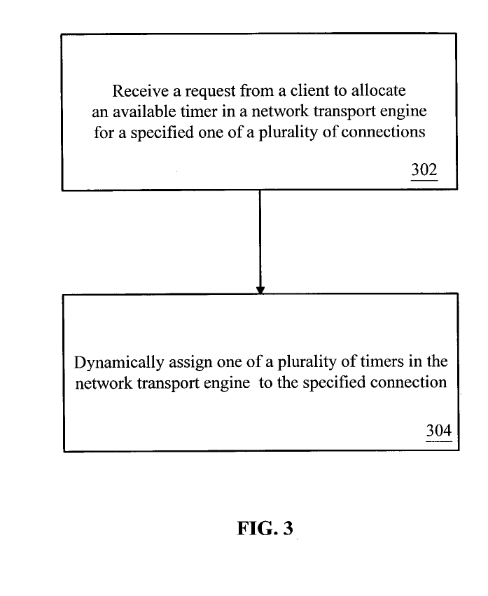

FIG. 3 illustrates a method according to one embodiment of the invention. At 302, a request is received from a client to allocate an available timer in a network transport engine for a specified one of a plurality of connections. At 304, one of a plurality of timers in the network transport engine is assigned to the specified connection. In one embodiment, information about the assigned timer is sent back to the client. In one embodiment, a determination is made as to whether any of the plurality of timers in the network transport engine are available. If there is at least one available timer, an available timer is assigned to the specified connection. If there are no available timers, the client request is stalled until a timer becomes available. In one embodiment, the client is notified when the assigned timer expires or times out. In one embodiment, a request is received from a client to de-allocate a timer that is no longer needed. In response to this request, the timer is de-allocated and becomes available. A request may also be received from a client to start or stop the timer.

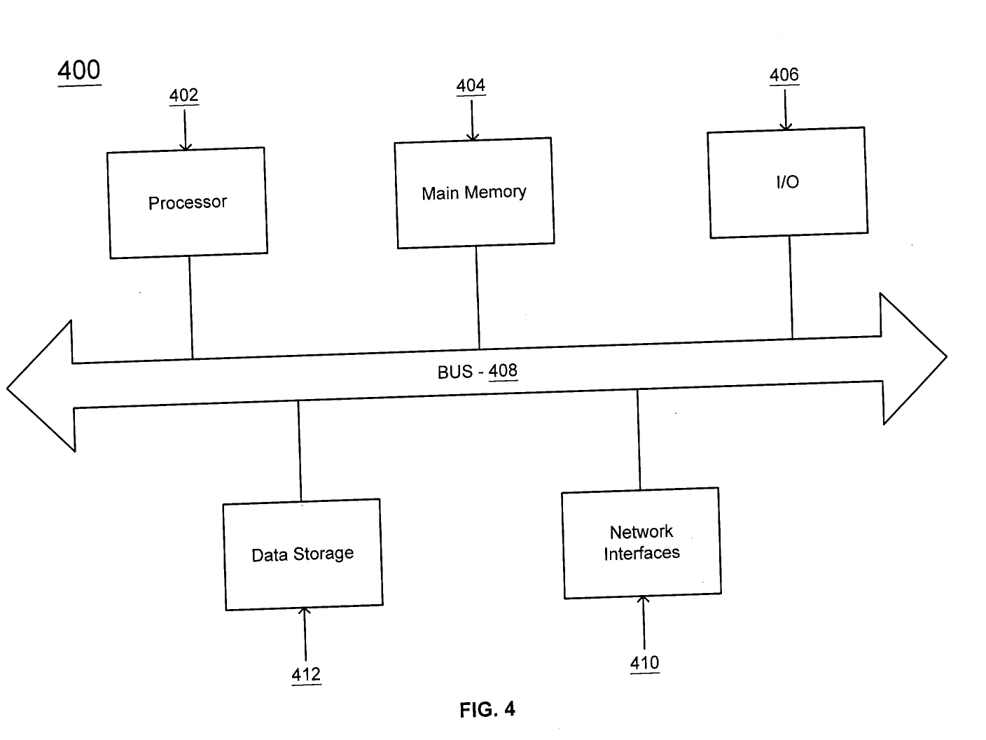

FIG. 4 is a block diagram illustrating a suitable computing environment in which certain aspects of the illustrated invention may be practiced. A computer system 400 has components 402-412, including a processor 402, a memory 404, an input/output device 406, a data storage 412, and a network interface 410, coupled to each other via a bus 408. The components perform their conventional functions known in the art and provide means for implementing a system incorporating the invention. Collectively, these components represent a broad category of hardware systems, including but not limited to general purpose computer systems and specialized packet forwarding devices. It is to be appreciated that various components of computer system 400 may be rearranged, and that certain implementations of embodiments of the invention may not require nor include all of the above components. Furthermore, additional components may be included in system 400, such as additional processors (e.g., a digital signal processor), storage devices, memories, and network or communication interfaces.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a request from a client to allocate an available timer in a network transport engine for a specified one of a plurality of connections; and
dynamically assigning one of a plurality of timers in the network transport engine to the specified connection.

2. The method of claim 1, further comprising sending information about the assigned timer to the client.

3. The method of claim 1, further comprising de-allocating the timer from the specified connection when the client indicates that the timer is no longer needed.

4. The method of claim 1, further comprising informing the client when the assigned timer expires.

5. The method of claim 1, wherein dynamically assigning one of a plurality of timers in the network transport engine to the specified connection comprises dynamically assigning one of a plurality of timers in the network transport engine to the specified connection if at least one of the plurality of timers is available.

6. The method of claim 5, further comprising stalling the client request if there are no available timers.

7. The method of claim 1, wherein dynamically assigning one of a plurality of timers in the network transport engine to the specified connection comprises maintaining a list of available timers in the network transport engine and assigning one of the timers in the list to the specified connection.

8. The method of claim 1, further comprising starting the assigned timer upon a request from the client.

9. The method of claim 8, further comprising stopping the assigned timer upon a request from the client.

10. A network transport engine comprising:
a plurality of connections;
a plurality of timers; and
timer logic to dynamically assign one of the plurality of timers to one of the plurality of connections.

11. The network transport engine of claim 10, wherein the timer logic to further maintain a list of available timers.

12. The network transport engine of claim 10, wherein the timer logic includes a memory to store information about the plurality of timers.

13. The network transport engine of claim 10, wherein the timer logic includes a counter to maintain the current time value.

14. An article of manufacture comprising:
a machine accessible medium including content that when accessed by a machine causes the machine to:
receive a request from a client to allocate an available timer in a network transport engine for a specified one of a plurality of connections; and
dynamically assign one of a plurality of timers in the network transport engine to the specified connection.

15. The article of manufacture of claim 14, wherein the machine accessible medium further includes content that causes the machine to send information about the assigned timer to the client.

16. The article of manufacture of claim 14, wherein the machine accessible medium further includes content that causes the machine to de-allocate the timer from the specified connection when the client indicates that the specified connection no longer needs the timer.

17. The article of manufacture of claim 14, wherein the machine accessible medium further includes content that causes the machine to inform the client when the assigned timer expires.

18. The article of manufacture of claim 14, wherein the machine accessible medium including content that when accessed by the machine causes the machine to dynamically assign one of a plurality of timers in the network transport engine to the specified connection comprises the machine accessible medium including content that when accessed by the machine causes the machine to dynamically assign one of a plurality of timers in the network transport engine to the specified connection if at least one of the plurality of timers is available.

19. The article of manufacture of claim 18, wherein the machine accessible medium further includes content that causes the machine to stall the client request if there are no available timers.

20. The article of manufacture of claim 14, wherein the machine accessible medium including content that when accessed by the machine causes the machine to dynamically assign one of a plurality of timers in the network transport engine to the specified connection comprises the machine accessible medium including content that when accessed by the machine causes the machine to maintain a list of available timers in the network transport engine and assign one of the timers in the list to the specified connection.

21. A system comprising:
a Target Channel Adapter (TCA); and
a Host Channel Adapter (HCA) coupled to the TCA, the HCA including:
a plurality of connections;
a plurality of timers; and
timer logic to dynamically assign one of the plurality of timers to one of the plurality of the connections upon client request.

22. The system of claim 21, wherein the timer logic includes a memory to store information about the plurality of timers.

23. The system of claim 21, wherein the HCA is connected to the TCA via an InfiniBand fabric.
